(19) United States
(12) Patent Application Publication
(10) Pub. No.: US 2010/0146628 A1
(43) Pub. Date: Jun. 10, 2010

(54) Combating Fraud in Telecommunication Systems

(76) Inventor: David Stewart, Coventry West Midlands (GB)

Correspondence Address: COATS & BENNETT, PLLC, 1400 Crescent Green, Suite 300, Cary, NC, 27518, US

(21) Appl. No.: 12/095,666

(22) PCT Filed: Nov. 30, 2006
(86) PCT No.: PCT/EP06/69167

§ 371 Date: Jun. 19, 2008

(30) Foreign Application Priority Data
Dec. 1, 2005 (GB) 0524399.3

(51) Int. Cl. H04N 7/16; H04L 12/66; H04L 12/26

(52) U.S. Cl. 726/26; 370/352; 370/235.1

(57) ABSTRACT

A method and apparatus for combating fraudulent use of a telecommunication system by subscribers who terminate calls improperly without allowing the termination of the call to be recorded, and thereby attempt to avoid correct payment for the call. The apparatus comprises a record means for creating a call detail record (CDR) of certain events for each call on which billing for each call can be based. A modified Call Agent (22) is provided for monitoring certain events related to all calls. The Call Agent (22) is also operable to check periodically whether a call is active or has been terminated improperly without the termination event having been recorded in the respective CDR for that call. A counter means (42) is provided that is operable, in the event of the Call Agent (22) detecting that a call has been terminated improperly by a selected subscriber, to start a count, that upon reaching a predetermined value, is used to shorten the time interval between subsequent periodic checks made by the Call Agent (22) in respect of subsequent calls involving the same selected subscriber.

This invention relates to a method and apparatus for combating fraudulent calls made over a public telecommunication systems and in particular Internet Protocol (IP) telecommunication systems.

Generally, public telecommunication systems are subject to regulations by governments that usually include restrictions on the error allowed in metering and billing of calls. In many regulatory regimes, telecommunication systems must not record a call as lasting longer that it actually did, and must not over charge for any call. There is therefore a tendency to under charge rather than to over charge.

To provide information for billing and statistics, telephony systems produce a Call Detail Record (CDR) for each call attempt. Each CDR contains timestamps of interesting events, such as Time of Seize, Time of Answer, and Time of Clear.

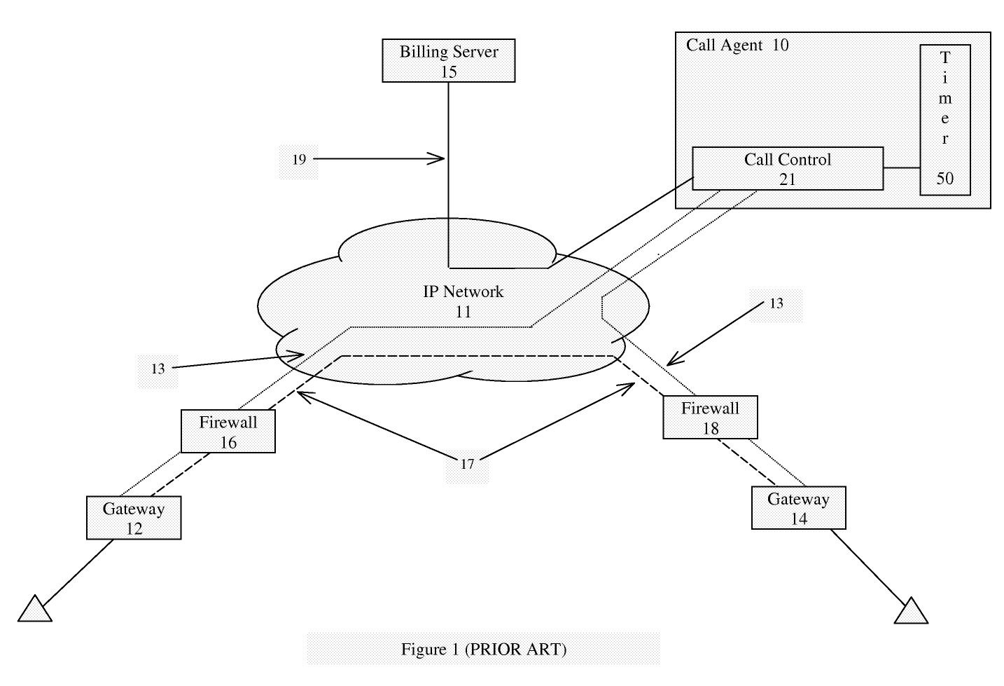

A typical prior known IP telecommunication system, as shown in FIG. 1, uses a Call Agent 10 that uses call and bearer control interfaces 13 to communicate with the gateways 12,14. The Call Agent 10 indirectly controls the speech path 17 across the IP network 11 by supplying the address of the called gateway 12 to the calling gateway 14, and vice-versa, once the call is connected, the speech path 17 across the network 11 remains connected until a “clear” signal is sent by one of the gateways 12, 14 to the Call Agent 10.

The caller is charged up until a “clear” signal is passed to the Call Agent 10 from one of the gateways 12, 14, and the “Time of Clear” is recorded in a Call Detail Record (CDR)

To overcome the risk of over charging, prior known systems only charge for the time of a call up until either a “clear” signal is received by the Call Agent 10 and recorded by the CDR for the specific call, or failing that, up until the last event monitored by the Call Agent 10 and recorded by the CDR for the specific call.

It is more difficult to monitor calls over an IP telecommunications system than over a channel-based system because the IP network connection may fail accidentally, or intentionally by powering down the node or stopping the program that controls the Internet connections. Consequently it is easier to perpetrate fraud over an IP telecommunication system than over a channel-based system.

The primary means whereby the Call Agent 10 knows that the call has ended is when it receives a message indicating, “clear”, from one of the gateways 12, 14. The “Time of Clear” recorded in the CDR is either the timestamp supplied in the “clear” message, or the time that the Call Agent 10 received the message, whichever is deemed most accurate.

The secondary means whereby the Call Agent 10 knows that the call has ended, is when the Call Agent 10 makes a periodic check of each long running call to see if it is still active. If a call is active at the time of the periodic check, no action is taken at that time. If a call is deemed not to be active at the time of the periodic check, the “Time Of Clear” that is recorded in the CDR is taken to be the time that the previous periodic check was performed. If a call is deemed not to be active at the time of the first periodic check, a time just after the “Time Of Answer” is taken to be the “Time Of Clear” and this is recorded in the CDR for that call.

The periodicity of the checks of long running calls is typically set to run at fixed intervals of several tens of minutes up to several hours (as much as 8 hours for some prior known systems). The longer the period between periodic checks, the more incentive there is for fraud. The prior known systems are therefore susceptible to fraud by collusion between the calling and called parties.

If the sending and receiving parties know the periodicity of the checks made by the Call Agent 10 for long calls, then both parties can terminate the call simultaneously just before the anticipated time of the next check, by powering down the node, or stopping the program that provides gateway functionality. As no “clear” message is sent by the gateways 12, 14 to the Call Agent 10, the Call Agent 10 must then use the secondary means mentioned above to determine when the call is likely to have finished.

If the parties collude, and the call is terminated just before the Call Agent 10 makes its periodic check, the Call Agent only detects the “Time of Answer” or the last time that a previous check was made, and therefore the caller is not charged for the actual length of the call, but instead is only charged up to the last event detected by the Call Agent 10.

It is impractical to monitor all calls often enough to prevent fraud completely. Therefore, the current practical solution in tackling this type of fraud is based around monitoring patterns of behaviour in CDRs of suspected fraudulent callers, and taking legal action against those suspected of fraud.

This is not only very costly to implement, but has a low probability of success, because it is impossible to monitor millions of calls effectively and many fraudsters escape detection. Consequently only a few of the fraudsters are likely to be prosecuted successfully.

An attempt to address this type of fraud, with present known systems is to connect “untrustworthy” gateways 12, 14 to the IP network 11 via firewalls 16, 18 that are controlled by the Call Agent 10 as shown in FIG. 1. The Call Agent 10 opens pinholes in the Firewalls 16, 18 at the start of each call from a suspected fraudster, and closes the pinholes at the end of the call. The times of opening and closing the pinholes are used to provide an indication of the length of the call. This solution is costly to implement widely, so is applied selectively and thus only offers a solution of monitoring persistent known fraudsters.

A slightly more complex solution considered in the past has been to have a pseudo-random frequency of check, with an average of the original periodicity, so that the processing usage would be the same as if the original periodicity had been used. However, this may not have sufficient deterrent effect, because there would still be a reasonable chance of determined fraudsters making a free call if it is truncated without a “clear” message being sent to the Call Agent.

A solution tried in the past has been to check more calls more frequently and generate a part-bill CDR. However, such an approach uses a lot of processing capacity on the Call Agent and gateways, and, if a part-bill CDR were generated for each check (as at present), then it uses a lot of processing capacity on the Billing Server 15. Such an approach is deemed impractical in most circumstances.

An object of the present invention is to provide a means of combating detecting suspect potential fraudsters by reducing the period between long-call checks on calls involving suspected fraudsters.

According to one aspect of the present invention there is provided apparatus for combating fraudulent use of a telecommunication system by subscribers who terminate calls improperly without allowing the termination of the call to be recorded and thereby attempt to avoid correct payment for the call, the apparatus comprising a record means for creating a Call Detail Record (CDR) of certain events for each call on which billing for each call can be based, a Call Agent for monitoring certain events related to all calls, said Call Agent also being operable to check periodically whether a call is active or has been terminated improperly without the termination event having been recorded in the respective CDR for that call, and a counter operable in the event of the Call Agent detecting that a call has been terminated improperly involving a specific subscriber, to keep a count of improperly terminated calls involving the specific subscriber that is used to shorten the time interval between the periodic checks made by the Call Agent in respect of subsequent calls involving the specific subscriber.

Thus, utilising the present invention, a subscriber suspected of fraud has the benefit of any fraud taken away automatically by the system without being aware that this is happening. This is achieved at little cost to the system, because all long calls are monitored and the periodicity of checks is shortened automatically, but only in those cases where it is likely that a subscriber is attempting to perpetrate a fraud.

Preferably the counter is a leaky bucket counter having a predetermined overflow level, and is operable to decrement the count each time a call involving the suspected fraudster is terminated improperly without the termination event having been recorded by the respective CDR for that call, and increment the count each time that a call is terminated properly and the termination event is recorded in the respective CDR for that call.

The counter may have a fixed overflow level. Alternatively the counter may have an adjustable overflow level and an adjusting means for selectively adjusting the overflow level. The adjusting means may be operable to adjust the overflow level by administratively modifying a data item associated with a particular subscriber. The adjusting means may be operable to adjust the overflow level by administratively modifying a data item associated with a set of subscribers.

Preferably the adjusting means is operable to adjust the overflow level by counting the number of times that a subscriber has been subject to periodic checks by the Call Agent of a time interval that is shorter than a predetermined time. In this case the adjusting means may be operable to adjust the overflow level by counting the total duration that a subscriber has been subject to periods between periodic checks of calls shorter than a predetermined time.

Preferably the adjusting means is operable to adjust the overflow level by leaky bucket count of the number of times that a subscriber has been subject to periods between periodic checks of calls shorter than a predetermined In this case the adjusting means may be operable to adjust the overflow level by keeping a leaky bucket count of the recent duration that a subscriber has been subject to periods between periodic checks of calls shorter than a predetermined time.

A count increment of the counter that is associated with an improperly terminated call, may be weighted to compensate for the potential lost revenue of that call.

The counter may be operable to count the cumulative number of all calls that were terminated improperly by a specific subscriber.

Preferably the apparatus is provided with a determination means for determining that a specific selected subscriber who has previously been treated as a suspected fraudster no longer deserves to be treated as a suspected fraudster, and the method comprises the further steps of receiving a predetermined output value from the determination means that is indicative of the need to lengthen the time interval between periodic checks made by the Call Agent against subsequent calls involving the same specific selected subscriber.

The determining means may comprise a second timer that is set to run for a predetermined length of time, and a control means is provided that operates to reset the timer and thereby lengthen the preset time in the event that the subscriber does not terminate calls properly during that pre set time, and to decrease the preset time in the event that the subscriber terminates calls properly within the preset time.

The second timer may be set to an initial fixed preset time. Preferably the timer is reset to a preset time that is proportional to the initial time each time that an improperly terminated call is detected by the Call Agent.

The preset time of the timer is inversely proportional to the time between the call that incremented the count from zero, and the call that overflowed the counter.

According to a further aspect of the present invention there is provided a method of combating fraudulent use of a telecommunication system by subscribers who terminate calls improperly without allowing the termination of the call to be recorded properly and thereby attempt to avoid correct payment for the call, the method comprising the steps of:
(a) creating a Call Detail Record (CDR) of certain events for each call on which billing for each call can be based;
(b) operating a Call Agent to monitor certain events related to all calls, and also to check periodically whether a call is active or has been terminated improperly without the termination event having been recorded in the respective CDR for that call; and
(c) operating a counter to keep a count of improperly terminated calls involving a selected subscriber suspected as a potential fraudster to produce a count that is used to shorten the time interval between the periodic checks made by the Call Agent in respect of subsequent calls involving the, or each, selected subscriber; and
(d) shortening the time interval between the periodic checks carried out by the Call Agent in relation to subsequent calls involving the, or each, selected subscriber in response to the count of step (c).

Preferably the step of operating the counter in the event of the Call Agent detecting that a call has been terminated improperly, comprises the step of starting a count that, upon reaching a predetermined value, is used to shorten the time interval between subsequent periodic checks made by the Call Agent in respect of subsequent calls involving the same selected subscriber.

Preferably the counter is a leaky bucket counter having a predetermined overflow level, and the step of operating the counter comprises the step of incrementing the count each time a call involving the same selected subscriber is terminated improperly without the termination event having been recorded by the respective CDR for that call, and the step of decrementing the count each time that a call involving the same selected subscriber is terminated properly and the termination event is recorded in the respective CDR for that call.

Where the counter is a leaky bucket counter, it may have a fixed overflow level or an adjustable overflow level. In the case where the counter has an adjustable overflow level the method includes the step of selectively adjusting the overflow level. This adjusting step may comprise administratively modifying a data item associated with a particular selected subscriber, or may comprise administratively modifying a data item associated with a set of selected subscribers.

In the case where the counter is a leaky bucket counter, the adjusting step may comprise adjusting the overflow level by counting the number of times that a selected subscriber has been subject to periodic checks by the Call Agent at time intervals shorter than a predetermined time.

In the case where the counter is a leaky bucket counter, the adjusting step may comprise the step of adjusting the overflow level by counting the total duration that a selected subscriber has been subject to periodic checks by the Call Agent at time intervals shorter than a predetermined time.

In the case where the counter is a leaky bucket counter, the adjusting step may comprise the step of adjusting the overflow level by using leaky bucket count of the number of times that a selected subscriber has been subject to periodic checks by the Call Agent at time intervals shorter than a predetermined time.

In the case where the counter is a leaky bucket counter, the adjusting step may comprise the step of adjusting the overflow level by keeping a leaky bucket count of the recent duration that a selected subscriber has been subject to periodic checks by the Call Agent at time intervals shorter than a predetermined time.

In this case where the counter is a leaky bucket counter, the adjusting step may comprise weighting a count increment of the counter that is associated with an improperly terminated call, thereby to compensate for the potential lost revenue of that call.

The step of operating the counter may be used to count the cumulative number of all calls that were terminated improperly by a specific subscriber.

The method according to the present invention preferably includes the step of determining that a specific subscriber who has been previously been treated as a suspected fraudster no longer deserves to be treated as a suspected fraudster, said determination step being operable in response to receiving a predetermined output value from the counter and comprising the step of lengthening the time interval between subsequent periodic checks made by the Call Agent against calls involving a specific selected subscriber.

The determining step may comprise the steps of operating a second timer that is set to run for a predetermined length of time, resetting the timer thereby to lengthen the preset time in the event that the selected subscriber does not terminate calls properly during that pre set time, and decreasing the preset time in the event that the subscriber terminates calls properly within the preset time. In this case the determining step may include the step of setting the second counter to an initial fixed preset time or to an adjustable initial preset time

The determining step may include the step of resetting the pre-set time of the second timer for a time to a time that is proportional to, or inversely proportional to, the initial time each time that an improperly terminated call is detected by the Call Agent.

In a further aspect of the invention, the Call Server may have means for detecting that a particular subscriber no longer deserves to be treated as a suspected fraudster and is operable to return such a subscriber to the normal period between long call checks. This has the advantage of limiting the costs to the system, because the number of suspect subscribers does not continue to grow.

The present invention will now be described by way of an example, with reference to the accompanying drawings, in which:

FIG. 1 is an example of a prior known internet protocol telecommunications system employing a Call Agent to monitor certain events of a call;

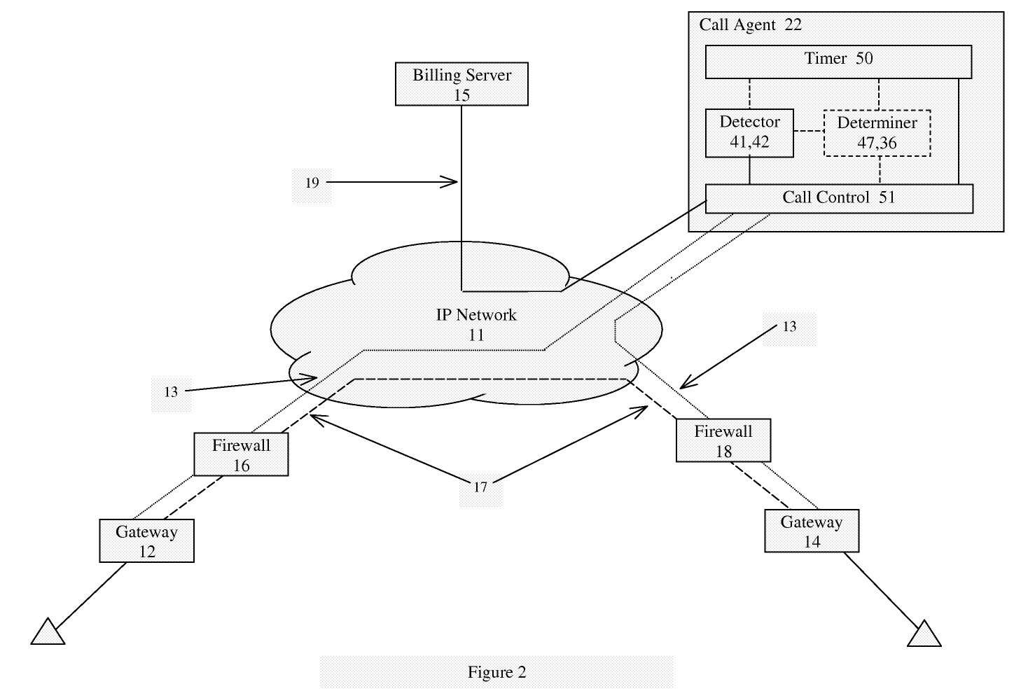

FIG. 2 shows, schematically, one embodiment of the present invention;

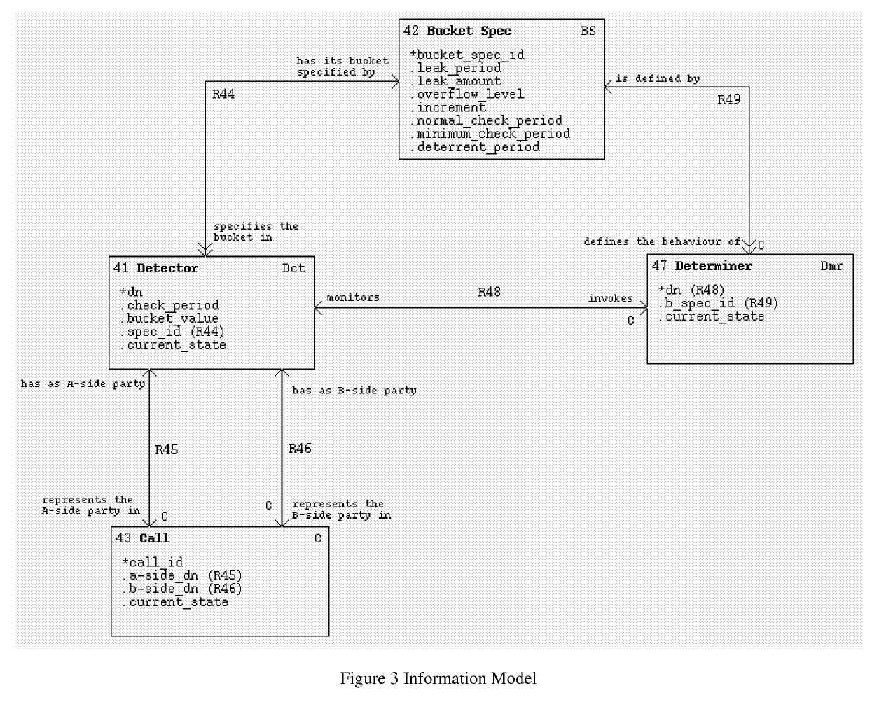

FIG. 3 is an Information Model, sometimes known as an Entity Relationship Diagram, showing the data items necessary for implementing the embodiment of the present invention shown in FIG. 2, and the relationships between them;

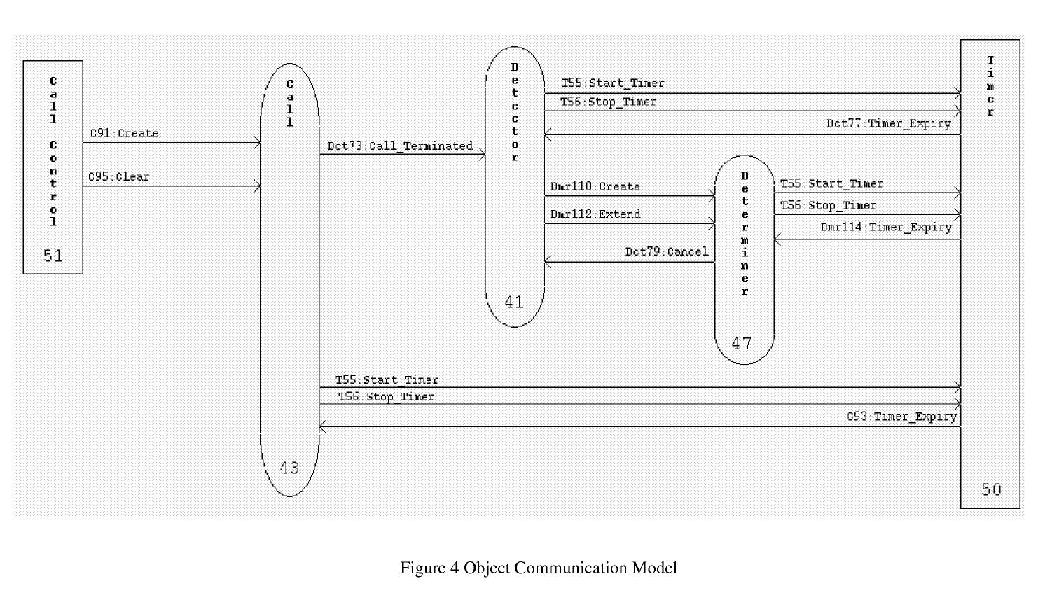

FIG. 4 is an Object Communication Model, showing the messages that pass between the objects of FIG. 3;

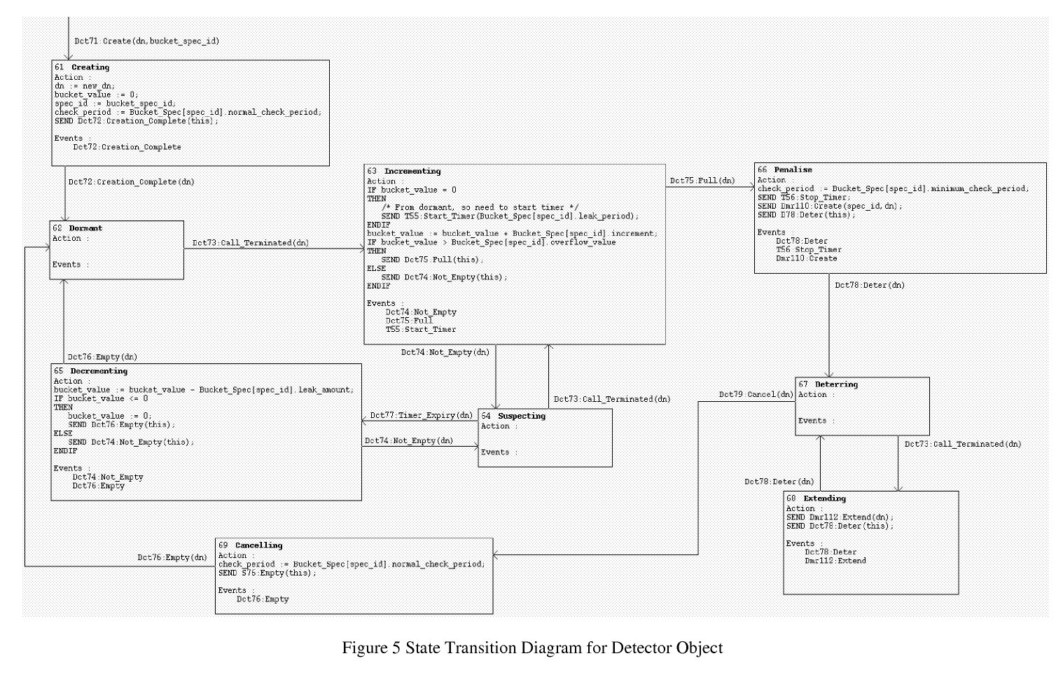

FIG. 5 is a state transition diagram for the Detector object shown in FIG. 3;

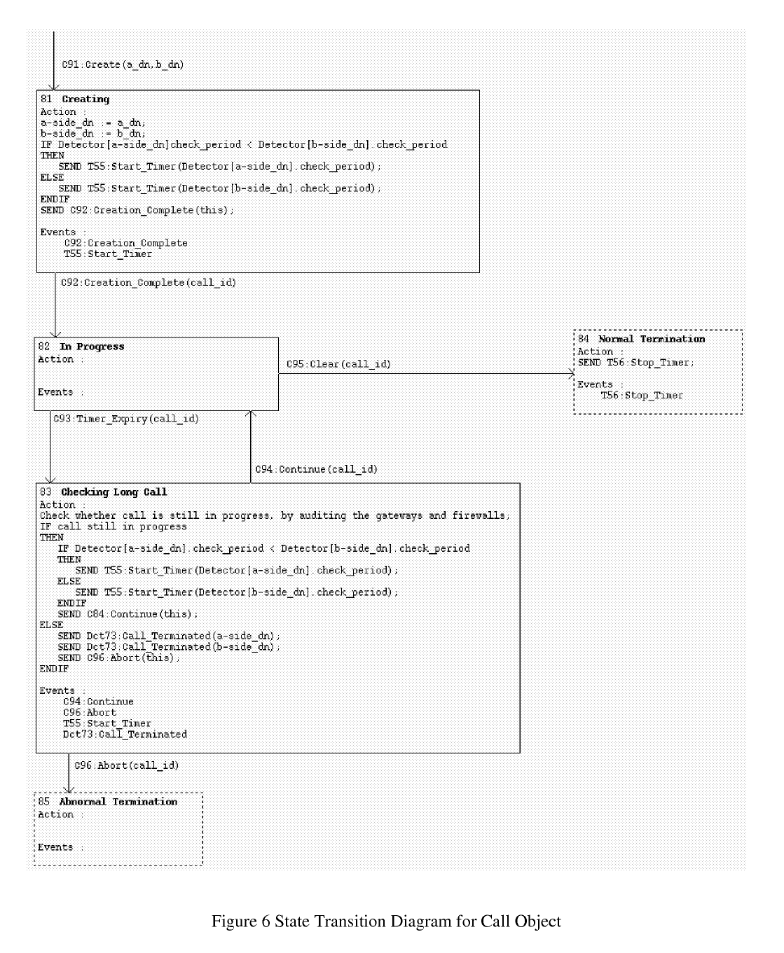

FIG. 6 is a state transition diagram for the Call object shown in FIG. 3; and

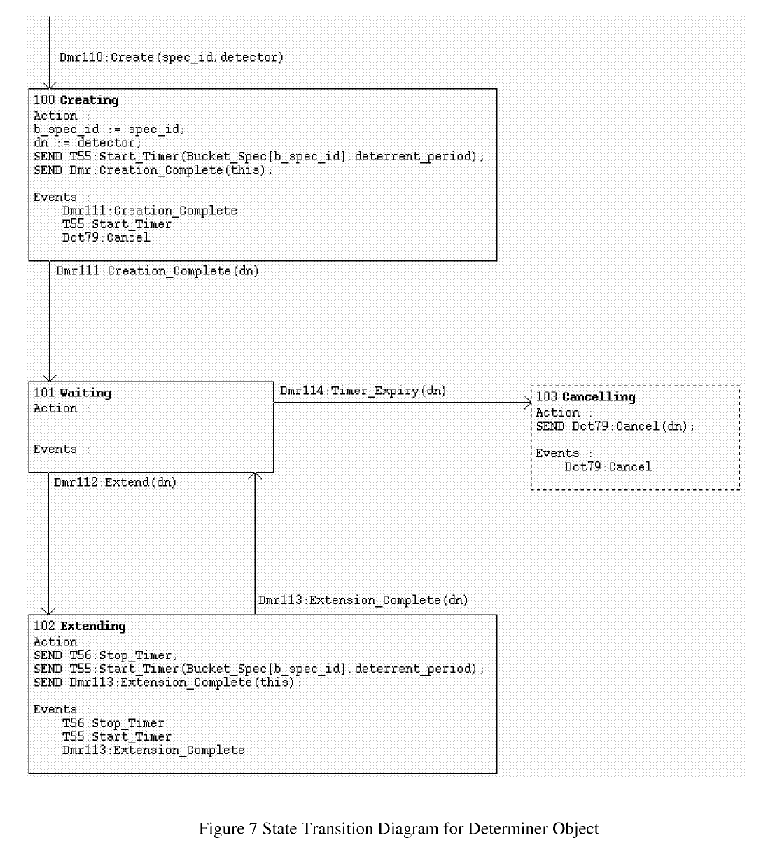

FIG. 7 is a state transition diagram for the Determiner object shown in FIG. 3.

Referring to FIG. 1, in prior known IP telecommunication systems, the Call Agent 10 indirectly controls the speech path through the IP network 11. The Call Agent having supplied the address of the calling gateway 12 to the called gateway 14, and vice-versa, a caller is able to use the speech path until a “clear” signal is sent by one of the gateways 12, 14.

If the sending and receiving parties know, or guess, the periodicity of the checks made by the Call Agent 10 for long calls, then if both parties terminate the call simultaneously just before the anticipated time of the next check by the Call Agent 10, by powering down the node, or stopping the program that provides gateway functionality, no “clear” signal is sent to the Call Agent 10. To address this, “untrustworthy” gateways 12, 14 are connected to the IP network 11 via Firewalls 16, 18 that are controlled by the Call Agent 10. The Call Agent 10 opens pinholes in the Firewalls 16, 18 at the start of a call, and closes the pinholes at the end of the call.

The primary means whereby the Call Agent 10 knows that the call should be recorded as having ended is when the Call Agent 10 receives a message indicating “clear” from one of the gateways 12, 14. In this case, the “Time of Clear” recorded in the CDR is taken to be either the timestamp supplied in the “clear” message from the gateway 12 or 14, or the time that the Call Agent 10 received the message, whichever is deemed the most accurate.

The network contains a Billing Server 15 for effecting billing functionality. The Call Agent has a path 19 through the IP Network 11 over which it passes each call's CDR to the Billing Server 15. Billing for each call is based on the CDR for each call. Each CDR contains information such as, for example, “Time Of Answer”, “Time Of Seize”, “Time Of Clear”, and call termination reason.

The secondary means whereby the Call Agent 10 knows that the call should be recorded as having ended is when the Call Control function 21 within the Call Agent 10 makes a periodic check that a long running calls is still active and finds that it is not active and no “clear” message has been received. The Call Control function 21 determines the appropriate moment to perform the periodic check by using the facilities of the Timer 50 function within the Call Agent 10

If a call is active at the time of the periodic check by the Call Agent 10 the

Call Agent 10 resumes periodic monitoring at the next fixed time interval. If a call is deemed not to be active at the time that the Call Agent 10 checks the call and no “clear” message has been received by the Call Agent 10 in respect of that specific call, the “Time of Clear” that is recorded in the CDR is taken to be the time of the previous periodic check carried out by the Call Agent 10.

If the periodic check is the first one made by the Call Agent 10 after the “answer” message has been received, and the call is not active at the time that the Call Agent 10 checks the call, a time just after the “Time Of Answer” is taken to be the “Time Of Clear” and this is recorded in the CDR for that call.

As explained above, this prior known scheme is susceptible to fraud by collusion between the calling and the called parties, and can be a major loss of revenue in those instances where a call of say 20 hours, is only recorded as a fraction of a second from the “Time Of answer” message being received by the Call Agent 10.

Referring now to FIG. 2, there is shown an IP telecommunication system embodying the present invention. The system is similar to that shown in FIG. 1 except for the addition of a detector 41 that includes a counter 42, and the components of the determiner 47 (as will be explained hereinafter). The detector 41 together with the determiner 47, constitute an apparatus for combating attempted fraud caused by subscribers deliberately terminating calls improperly over a telecommunications system without recording the termination event.

The system of FIG. 2 comprises a modified Call Agent 22 for monitoring certain events related to each call. The Call Agent 22 controls the speech path 17 indirectly through the IP network by means of the call and bearer control path, shown schematically by the numeral 13, and the subscriber) the caller is charged up until a “clear” signal is passed to the Call Agent 22 from one of the gateways 12, 14. The Call Agent 22 supplies the address of the called gateway 12 to the calling gateway 14, and vice-versa, and once the call is connected, the speech path 17 across the network remains connected until a “clear” signal is sent by one of the gateways 12, 14 to the Call Agent 22.

The Call Control 51 within the Call Agent 22 is operable to check the status of each call periodically. The time interval of the periodic checks made by the Call Control 51 can be any fixed time interval, and may be a few minutes or, as is usual in some existing system a few hours up to 8 hours is not unusual.

Each periodic check made by the Call Control 51 determines whether a call is active or has been terminated improperly, without the termination event having been recorded in the respective CDR, prior to the time that the periodic check is made by the Call Control 51. The Call Agent 22 includes a detection means 41 that is operable to identify the subscriber as a suspected fraudster in the event of detecting that a call has been terminated improperly, as will be explained in detail below.

The detector 41 operates to shorten the time interval between subsequent checks made by the Call Control 51 in respect of calls involving the suspected fraudster, as will be explained in more detail below, and thereby effectively reduce the opportunity of a suspected fraudster continuing deliberately to abuse the recording of appropriate charges.

In the example embodiment of the invention shown in FIGS. 2 to 7, the detector 41 comprises a leaky bucket counter 42.that increments the count each time a call involving a suspected fraudster is terminated abnormally, such as for example by powering down the node by the subscriber whether that be the caller, or the called person, irrespective as to whether this occurs accidentally or intentionally, as detected by periodic call monitoring checks made by the Call Control 51.

The count of the counter 42 is decremented periodically by the detector means 41; the periodicity of the decrement is independent of the frequency of the checks of the call made by the Call Control 51. If the count of the counter overflows a preset overflow value, the subscriber is treated as a “suspected fraudster”.

The detector 41 is tuneable by changing the number of counts added to the leaky bucket count for each call that is terminated abnormally (as detected by a periodic check made by the Call Control 51), by changing the frequency of decrementing the leaky bucket count, and by changing the overflow level (X.)

The effect of the mechanism is further tuneable by altering the time interval of the period between subsequent checks made by the Call Control 51.

In a preferred embodiment of the invention, the Call Agent 22 includes a determiner 47 operable for determining that a subscriber no longer deserves to be treated as a “suspected fraudster”. The determiner 47 comprises a timer 36 that is set to run for a preset time (Y), during which a properly created “clear” signal is generated against each call that the “suspected fraudster” is involved in. If the subscriber is involved in a subsequent call that is terminated improperly (as detected by a periodic check by the Call Control 51), the timer 36 is restarted, and counts down from the preset time.

If the timer 36 expires (because every call has been terminated properly by generating a “clear” message), the subscriber is then identified as no longer needing to be treated as a suspect fraudster, and the time interval between subsequent periodic checks made by the Call Control 51 is lengthened or returned to the normal period of checks. This releases the Call Agent 22 from needing to monitor that particular suspected fraudster to monitor other suspected fraudsters.

FIG. 3 is an Information Model, sometimes known as an Entity Relationship Diagram, showing the data items necessary for implementing the embodiment of the present invention shown in FIG. 2, and the relationships between them.

Object 41 (Detector) represents an end-user of the telecommunication system of FIG. 2 (Only one Subscriber 41 is shown). Each Detector has an identity consisting of a single attribute (directory number). This is shown as an abbreviation (dn) in the diagram to make the diagram more readable. Each Detector contains three further attributes, namely:
(a) check_period—containing the duration, in seconds, which calls involving this subscriber are allowed to continue before being audited;
(b) bucket_value—containing the current value of the leaky bucket; and,
(c) spec_id—containing the identity of the Bucket Spec that this Detector complies with.

In addition, each Detector contains a state variable, (current state), which identifies the Detector's place in its state machine.

Object 42 (Bucket_Spec) in FIG. 3 represents the behaviour of the leaky bucket counter in many Detectors 41 and the timer in the Determiners 47 associated with those Detectors. Each Bucket_Spec has an identity consisting of a single attribute, (bucket_spec_id). Each Bucket_Spec contains seven further attributes:
(a) leak_period—containing the period in seconds between successive decrements of buckets that meet this specification;
(b) leak amount—containing the amount that buckets that meet this specification are decremented each leak_period;
(c) overflow_level—containing the value of buckets that meet this specification above which it is deemed they have overflowed;
(d) increment—containing the amount that buckets that meet this specification are increased each time a call is terminated by an audit;
(e) normal_check_period—containing the period in seconds that calls involving subscribers using this Bucket Spec are allowed to continue before auditing, in normal circumstances;
(f) minimum_check_period—containing the period in seconds that calls involving subscribers using this Bucket_Spec are allowed to continue before auditing, after the bucket has overflowed; and
(g) deterrent_period—containing the period in seconds that a subscriber's check period is held at the minimum check period, for subscribers using this Bucket Spec

Object 43 Call, of FIG. 3 represents a call between two end-users. Each call has an identity consisting of a single attribute, “call_id”. Each Call 43 contains two attributes: “a-side_dn”, (containing the identity of the Subscriber that initiated the call); and “b-side_dn” (containing the identity of the Subscriber that received the call) In addition, each Call 43 contains a state variable, “current_state”, which identifies the Call's place in its state machine.

FIG. 4 is an Object Communication Model, showing the messages that pass between the objects shown in FIG. 3. These messages will be discussed in detail below with reference to FIGS. 5, 6, and 7.

In addition to the three state machines, Detector 41, Call 43, and Determiner 47 identified on the Information Model shown in FIG. 3, FIG. 4 shows two terminators, namely
(a) Timer 50—representing the Timing function on the Call Agent; and
(b) Call Control 51—representing the existing software on the Call Agent that manages connections between end-users.

FIGS. 5, 6, and 7 are State Transition Diagrams. In these state transition diagrams, each state is represented by a box containing the action associated with that state. The action associated with a state is performed each time a state is entered. To keep the state machine simple, the object (Detector) 41, Call 43, or Determiner 47 can send messages to itself; the state machine processes these messages before messages from any other object.

To initialise these state machines, the following pattern is used: a special message, “Create”, is used to enter a special state (Creating). The action associated with state (Creating) is to initialise the object's data and send a Creation_Complete message to this object. In addition to the description of the actions associated with a state, each state box contains an unordered list of messages generated by the state's action.

FIG. 5 is the State Transition Diagram for the Detector object 41, according to the preferred embodiment of the present invention. Operation of the Detector 41 will now be described with reference to FIG. 5.

As indicated in FIG. 5, from the state 61 (Creating), the Detector 41 enters state 62 (Dormant), with its attributes suitably initialised. Detector will remain in state 62 (Dormant) until it receives a message.

In state 62 (Dormant), Detector 41 can receive the following message: Dct73:Call_Terminated from the Call object 43 causes Detector 41 to transition to state 73 (Incrementing). If the bucket_value is currently 0, then Detector 41 sends message T55:Start_Timer to the Timer terminator 50 to start the leak period timer.

bucket_value is increased by the value of the increment attribute of the associated Bucket Spec 42. If bucket_value is now greater than the value of the overflow_level attribute of the associated Bucket Spec, Detector 41 sends message Dct75:Full to itself, which causes Detector 41 to transition to state 66 (Penalise)

In state 66 (Penalise), Subscriber 41 sets check_period to the value of the minimum_check_period attribute of the associated Bucket_Spec 42, sends message T56:Stop_Timer to the Timer terminator 50 to stop the leak period timer, sends message Dmr110:Create to create a Determiner 47, and sends message Dct78:Deter to itself, which causes Detector 41 to transition to state 67 (Deterring). Otherwise, Detector 41 sends message Dct74:Not_Empty to itself, which causes Detector 41 to transition to state 64 (Suspecting)

Detector 41 will remain in state 64 (Suspecting) until it receives a message. In state 64 (Suspecting), Detector 41 can receive any of the following two messages:
(a) Dct73:Call_Terminated from the Call object 43 causes Detector 41 to transition to state 63 (Incrementing), where it performs the same actions as when the Dct73:Call_Terminated message is received in state 62 (Dormant).
(b) Dct77:Timer_Expiry from the Timer terminator 50 causes Detector 41 to transition to state 65 (Decrementing). The bucket_value is then decremented by the value of the leak_amount attribute in the associated Bucket Spec 42.
If the bucket_value is now less than, or equal to, zero, Detector 41 sets the bucket_value to zero, then sends message Dct76:Empty to itself, which causes Detector 41 to transition to state 62 (Dormant). Otherwise, Detector 41 sends message Dct74:Not_Empty to itself, which causes Detector 41 to transition back to state 64 (Suspecting).

Detector 41 will remain in state 67 (Deterring) until it receives a message. In state 67 (Deterring), Detector 41 can receive any of the following two messages:
(a) Dct73:Call_Terminated from the Call object 43 causes Detector 41 to transition to state 68 (Extending). Detector 41 sends message Dmr112:Extend to the Determiner object 47, and sends message Dct78:Deter to itself, which causes Detector 41 to transition back to state 67 (Deterring)
(b) Dct79:Cancel from the Determiner object 47 causes the Detector 41 to transition to state 69 (Cancelling) Detector 41 sets check period to the value of the normal_check_period attribute of the associated Bucket_Spec 42, and sends message Dct76:Empty to itself, which causes the Detector 41 to transition to state 62 (Dormant).

FIG. 6 is the State Transition Diagram for the Call object 43, according to the preferred embodiment of the present invention. Operation of Call 43 will now be described with reference to FIG. 6.

As indicated in FIG. 6, in state 81 (Creating), Call 43 initialises its attributes, and starts a check period timer for the minimum of the check periods of the two Detectors 41 involved in the call. Call 43 then sends message C92:Creation_Complete to itself, causing Call 43 to transition to state 82 (In Progress)

Call 43 will remain in state 82 (In Progress) until it receives a message. In state 82 (In Progress), Call 43 can receive any of the following two messages:
(a) C93:Timer_Expiry from the Timer terminator 50 causes Call 43 to transition to state 83 (Checking Long Call). Call 43 performs the existing checks on gateways 12, 14 on FIG. 2, and firewalls 16, 18 on FIG. 2 to determine if the connection still exists. If the connection still exists, Call 43 sends message T55:Start_Timer to the Timer terminator 50 with the minimum of the check periods of the two Detectors 41 involved in the call, and sends message C94:Continue to itself, which causes Call 43 to transition back to state 82 (In Progress).Otherwise, Call 43 sends message Dct73:Call_Terminated to both Detectors 41 involved in the call. Call 43 then sends message C96:Abort to itself, which causes Call 43 to transition to terminal state 85 (Abnormal Termination).
(b) C95:Clear from the Call Control terminator 51 causes Call 43 to transition to terminal state 84 (Normal Termination). Call 43 sends message T56:Stop_Timer to the Timer terminator 50, then destroys itself.

FIG. 7 is the State Transition Diagram for the Determiner object 47, according to the preferred embodiment of the present invention. Operation of Determiner 47 will now be described with reference to FIG. 7.

As indicated in FIG. 7, in state 100 (Creating), Determiner 47 initialises its attributes, and sends message T55:Start_Timer to the Timer terminator 50 to start a timer 36 of the duration indicated in the deterrent_period attribute of the associated Bucket Spec 42, then sends message Dmr111:Creation_Complete to itself, causing Determiner to transition to state 101 (Waiting).

Determiner 47 will remain in state 101 (Waiting) until it receives a message. In state 101 (Waiting) Determiner can receive any of the following two messages:
(a) Dmr112:Extend from the Detector object 41 causes Determiner 47 to transition to state 102 (Extending) In state 102 (Extending), Determiner 47 sends message T56:Stop_Timer to the Timer terminator 50 to cancel the existing running timer, sends message T55:Start_Timer to the Timer terminator 50 to start a timer of the duration indicated in the deterrent_period attribute of the associated Bucket Spec 42, then sends message Dmr113:Extension_Complete to itself, which cause Determiner 47 to transition back to state 101 (Waiting).
(b) Dmr114:Timer_Expiry from the Timer terminator 50 causes

Determiner 47 to transition to state 103 (Cancelling). In state 103 (Cancelling), Determiner 47 sends message Dct79:Cancel to its associated Detector object 41, then destroys itself.

In a further embodiment of the invention, the count increment of the counter 42 in the Detector 41 that is associated with an improperly terminated Call (detected by a periodic check made by the Call Agent 22 from a specific suspected fraudster), may be weighted to compensate for the potential lost revenue of that call. One could calculate the potential lost revenue for calls involving a specific subscriber using the counter to count the cumulative time of calls that were terminated abnormally by the specific subscriber. The specific subscriber would be taken as confirmed as a suspect when the count reaches some predetermined level.

This latter mentioned detector 41 is tuneable by changing the amount added to the count for each type of call terminated by a periodic check, changing the overflow level (X), changing the frequency of decrementing the leaky bucket count, and applying a weighting factor to compensate for the potential loss of revenue. In this way persistent fraudsters will have a very much shortened time interval between subsequent checks by the Call Agent 22.

In a further embodiment of the present invention, the counter 42 in the detector 41 may be operable to take a cumulative count of all calls involving the specific suspected fraudster that were terminated improperly (as detected by the periodic check by the Call Agent 22). When the count reaches some predetermined cumulative level, the suspected fraudster would be confirmed as a fraudster, and the periodicity of the checks made by the Call Agent 22 shortened thereby to reduce the possibility of further fraud.

This detector 41 can be made tuneable by changing the amount added to the count of the counter 42 for each call terminated by a periodic check by the Call Agent 22, and changing the overflow level (X)

The determiner 47 is provided for determining that a subscriber no longer deserves to be treated as a likely fraudster could be implemented in many ways.

For example, a simple timer 36 that is set to run for a predetermined length of time could implement the determining means within the Determiner 47. If the subscriber does not terminate calls improperly in the preset time, the subscriber would be deemed to be no longer a suspected fraudster, and the preset time could be reduced and/or the time interval for re-checking the calls by the Call Agent 22 returned to the normal period as for subscribers that are not suspected as a likely fraudster.

If the subscriber transgresses within that preset time and terminates calls improperly, the timer 36 would be reset for the same, or a longer preset time and calls involving that subscriber would be subjected to more frequent periodic checks by the Call Agent 22.

The timer 36 could be reset for a longer duration each time a call involving the suspected fraudster is terminated by a periodic check made by the Call

Agent 22. The duration of the timer 36 may be inversely proportional to the incrementing duration, (i.e. the time between the call that incremented the count from zero, and the call that overflowed the counter).

The initial duration of the timer 36 could be fixed, and subsequent durations could be extended by a fixed amount or extended by a proportion of the previous amount and the extension times could be inversely proportional to the incrementing time. This determining means would be tuneable by changing the base duration of the timer, and the relationship between the incrementing duration and the preset time of the timer.

1-40. (canceled)

41. An apparatus for combating the fraudulent use of a telecommunication system by subscribers who terminate calls improperly without allowing the termination of the call to be recorded, and thereby attempt to avoid correct payment for the call, the apparatus comprising:
a recorder configured to create a Call Detail Record (CDR) of selected call events for each call on which billing for each call can be based;
a Call Agent configured to:
monitor selected events associated with all calls; and
perform a periodic check to determine whether a given call is active or has been improperly terminated without a termination event having been recorded in the CDR for that call; and
a counter configured to:
maintain a count of improperly terminated calls involving a given subscriber responsive to detecting that a call associated with the given subscriber has been terminated improperly; and
shorten a time interval between the periodic checks performed by the Call Agent on subsequent calls involving the given subscriber, based on the count.

42. The apparatus of claim 41 wherein the counter is further configured to:
initialize the count of improperly terminated calls involving the given subscriber when the Call Agent detects that a call involving the given subscriber has been improperly terminated; and
shorten the time interval between the periodic checks performed by the Call Agent on subsequent calls involving the given subscriber, when the count reaches a predetermined value.

43. The apparatus of claim 41 wherein the counter comprises a leaky bucket counter having a predetermined overflow level, and is configured to:
increment the count each time a call is terminated improperly without the termination event having been recorded by the respective CDR for that call; and
decrement the count each time a call is terminated properly and the termination event is recorded in the respective CDR for that call.

44. The apparatus of claim 41 wherein the counter comprises a leaky bucket counter having a predetermined overflow level, and is configured to:
decrement the count each time a call involving the given subscriber is terminated improperly without the termination event having been recorded by the respective CDR for that call; and
increment the count each time that a call involving the given subscriber is terminated properly and the termination event is recorded in the respective CDR for that call.

45. The apparatus of claim 41 wherein the counter has a fixed predetermined overflow level.

46. The apparatus of claim 41 wherein the counter has an adjustable overflow level, and further comprising an adjuster configured to selectively adjust the overflow level.

47. The apparatus of claim 46 wherein the adjuster is configured to adjust the counter overflow level by modifying a data item associated with a particular subscriber.

48. The apparatus of claim 46 wherein the adjuster is configured to adjust the counter overflow level by modifying a data item associated with a set of subscribers.

49. The apparatus of claim 46 wherein the adjuster is configured to adjust the counter overflow level by counting the number of times that a subscriber has been subjected to periodic checks of calls wherein the time interval between the periodic checks is shorter than a predetermined time.

50. The apparatus of claim 46 wherein the adjuster is configured to adjust the counter overflow level by counting an elapsed time during which the subscriber has been subjected to periodic checks of calls wherein the time interval between the periodic checks is shorter than a predetermined time.

51. The apparatus of claim 46 wherein the counter comprises a leaky bucket counter that counts the number of times that a subscriber has been subjected to periodic checks of calls wherein the time interval between the periodic checks is shorter than a predetermined time, and wherein the adjuster is configured to adjust the counter overflow level based on the leaky bucket count.

52. The apparatus of claim 46 wherein the counter comprises a leaky bucket counter that maintains an elapsed time indicating a recent duration during which a subscriber has been subjected to periodic checks of call wherein the time interval between the periodic checks is shorter than a predetermined time, and wherein the adjuster is configured to adjust the counter overflow level based on the leaky bucket count.

53. The apparatus of claim 41 wherein the counter that is associated with an improperly terminated call is configured to be incremented with a weighted value to compensate for potential lost revenue of that call.

54. The apparatus of claim 53 wherein the counter is configured to count a cumulative number of calls that are terminated improperly by the given subscriber.

55. The apparatus of claim 41 further comprising a determiner configured to:
determine that the given subscriber, who has been previously suspected of fraudulently terminating calls, should no longer be treated as a suspected fraudster; and
lengthen the time interval between the periodic checks performed by the Call Agent on subsequent calls involving the given subscriber, based on the count maintained by the counter.

56. The apparatus of claim 55 wherein the determiner comprises a timer that is set to run for a predetermined length of time, and further comprising a controller configured to reset the timer to increase the predetermined length of time if the given subscriber improperly terminates calls during the predetermined length of time.

57. The apparatus of claim 56 wherein the controller is further configured to decrease the predetermined length of time if the given subscriber terminates calls properly within the predetermined length of time.

58. The apparatus of claim 56 wherein the timer is initialized to an initial fixed predetermined time.

59. The apparatus of claim 58 wherein the timer is reset to a predetermined time that is proportional to the initial fixed time whenever the Call Agent detects an improperly terminated call.

60. The apparatus of claim 58 wherein the timer is reset to a predetermined time that is inversely proportional to a time between when a first call causes the counter to increment the count to a non-zero value and a second call that overflows the counter.

61. A method of combating the fraudulent use of a telecommunication system by subscribers who terminate calls improperly without allowing the termination of the call to be recorded properly, and thereby attempt to avoid correct payment for the call, the method comprising:
creating a Call Detail Record (CDR) by recording selected call events for each call, on which billing for each call can be based;
monitoring selected events associated with the calls at a Call Agent;
performing periodic checks at the Call Agent to determine whether a given call is active or has been terminated improperly without a termination event having been recorded in the respective CDR for that call;
maintaining a counter that counts improperly terminated calls involving a given subscriber responsive to detecting that a call associated with the given subscriber has been terminated improperly; and
shortening a time interval between the periodic checks performed by the Call Agent for subsequent calls involving the given subscriber based on the counter.

62. The method of claim 61 wherein maintaining a counter comprises initializing the counter when the Call Agent detects that the call has been improperly terminated, and wherein shortening a time interval between the periodic checks performed by the Call Agent comprises shortening the time interval when the counter reaches a predetermined value.

63. The method of claim 61 wherein the counter comprises a leaky bucket counter having a predetermined overflow level, and wherein maintaining the counter comprises:
incrementing the counter each time a call involving the given subscriber is terminated improperly without a termination event having been recorded by the respective CDR for that call; and
decrementing the counter each time that a call involving the given subscriber is terminated properly and a termination event is recorded in the respective CDR for that call.

64. The method of claim 61 wherein the counter comprises a leaky bucket counter having a predetermined overflow level, and wherein maintaining the counter comprises:
decrementing the counter each time a call involving the given subscriber is terminated improperly without a termination event having been recorded by the respective CDR for that call; and
incrementing the counter each time that a call involving the same selected subscriber is terminated properly and a termination event is recorded in the respective CDR for that call.

65. The method of claim 64 wherein the counter has a fixed overflow level.

66. The method of claim 64 wherein the counter has an adjustable overflow level, and wherein maintaining the counter comprises selectively adjusting the overflow level.

67. The method of claim 66 wherein selectively adjusting the overflow level comprises adjusting the overflow level by administratively modifying a data item associated with a selected subscriber.

68. The method of claim 66 wherein selectively adjusting the overflow level comprises adjusting the overflow level by administratively modifying a data item associated with a set of subscribers.

69. The method of claim 66 wherein selectively adjusting the overflow level comprises adjusting the overflow level by counting the number of times that a selected subscriber has been subjected to periodic checks by the Call Agent at time intervals that are shorter than a predetermined time.

70. The method of claim 66 wherein selectively adjusting the overflow level comprises adjusting the overflow level by counting a cumulative time duration that a selected subscriber has been subjected to periodic checks by the Call Agent at time intervals that are shorter than a predetermined time.

71. The method of claim 66 wherein the counter comprises a leaky bucket counter that counts the number of times that a selected subscriber has been subjected to periodic checks by the Call Agent at time intervals shorter than a predetermined time, and wherein selectively adjusting the overflow level comprises adjusting the overflow level based on the leaky bucket counter.

72. The method of claim 66 wherein the counter comprises a leaky bucket counter that maintains a count indicative of an elapsed time during which a selected subscriber has been subject to periodic checks by the Call Agent at time intervals shorter than a predetermined time, and wherein selectively adjusting the overflow level comprises adjusting the overflow level based on the leaky bucket counter.

73. The method of claim 66 w wherein selectively adjusting the overflow level comprises weighting a value that will be used to increment the counter that is associated with an improperly terminated call to compensate for a potential lost revenue of that call.

74. The method of claim 61 wherein maintaining a counter comprises counting a cumulative number of calls that were terminated improperly by a selected subscriber.

75. The method of claim 61 further comprising:
determining that the given subscriber, who has been previously suspected of fraudulently terminating calls, should no longer be treated as a suspected fraudster; and
lengthening the time interval between the periodic checks performed by the Call Agent on subsequent calls involving the given subscriber responsive to a predetermined value indicating that the given subscriber should no longer be treated as a suspected fraudster.

76. The method of claim 75 wherein a determiner having a timer determines whether the given subscriber should no longer be treated as a suspected fraudster, and further comprising:
initializing the timer to run for a predetermined time; and
resetting the timer to lengthen the predetermined time if the given subscriber improperly terminates calls during predetermined time.

77. The method of claim 76 further comprising shortening the predetermined time if the given subscriber terminates calls properly within the predetermined time.

78. The method of claim 76 wherein initializing the timer to run for a predetermined time comprises initializing the timer to a fixed time.

79. The method of claim 76 wherein resetting the timer comprises resetting the timer to a predetermined time that is proportional to the fixed time whenever the Call Agent detects that the given subscriber has improperly terminated a call.

80. The method of claim 77 wherein resetting the timer comprises resetting the timer to a predetermined time that is inversely proportional to an elapsed time between a first call that incremented the counter to a non-zero value, and a second call that overflowed the counter.
